(19) United States
(12) Patent Application Publication
(10) Pub. No.: US 2026/0233677 A1
(43) Pub. Date: Aug. 13, 2026

(54) RUNNING BOARD FOR A MOTOR VEHICLE

(71) Applicant: Brose Fahrzeugteile SE & Co. Kommanditgesellschaft, Bamberg, Bamberg (DE)

(72) Inventor: Daniel FOERST, Bamberg (DE)

(73) Assignee: Brose Fahrzeugteile SE & Co. Kommanditgesellschaft, Bamberg, Bamberg (DE)

(21) Appl. No.: 19/051,860

(22) Filed: Feb. 12, 2025

(51) Int. Cl. B60R 3/00; B60R 3/02

(52) U.S. Cl. CPC B60R 3/002; B60R 3/02

(57) ABSTRACT

A running board for a motor vehicle comprising a board having a tread surface and a radar sensor which is attached to the board. A flap system is also provided.

### BACKGROUND OF THE INVENTION

### Field of the Invention

The invention relates to a running board for a motor vehicle and a flap system for a motor vehicle, with a running board. The running board has a tread surface.

### Description of the Background Art

Motor vehicles, such as passenger cars, usually have a number of flaps, each of which covers an opening in the vehicle body. The flap is usually movably mounted on the body of the vehicle via a bearing, so that the opening of the body can be released by adjusting the flap. If the flap is a side door, it is therefore possible to enter the interior of the motor vehicle and/or load the interior with objects.

To increase comfort, the flap is usually driven by an electric motor. It is possible that one cannot fully see the area through which the flap is then adjusted, and that the electric motor is activated even though there is an obstacle there. To avoid a collision of the flap with the obstacle, which could lead to damage to the obstacle and/or the flap, the area is monitored via a collision protection sensor. If the obstacle is detected, for example, the current supply to the electric motor is stopped so that the flap is not adjusted. In most cases, an acoustic signal is also emitted, so that the user is informed that adjustment is currently not possible due to the obstacle.

A capacitive sensor, for example, can be used as such a collision protection sensor. However, this has a comparatively low spatial resolution.

An alternative to this is monitoring via a camera, wherein undisturbed operation requires appropriate illumination of the environment. Contamination of the camera also interferes with its operation comparatively strongly. A preferred variant is therefore to use a radar sensor, which can essentially detect a corresponding obstacle, regardless of the weather, with a comparatively accurate spatial resolution. It is also not apparent to the user that the sensor is in operation, so that the user is not inconvenienced.

Usually, the radar sensor is located in the area of an exterior mirror or a trim, provided that a side door is used as a flap. The radar sensor's visual axis, around which the radar sensor's monitoring area is formed, is usually arranged essentially horizontally. As a result, it is possible that obstacles, which are comparatively close to the motor vehicle and have only a slight height extension, are outside the monitoring area and therefore not detected, such as a curb. However, if the obstacle exceeds a certain minimum height, the lower edge of the door is moved against said obstacle when it is opened. Also, due to the door having a mostly bulbous design, the monitoring range of the radar sensor is restricted. To avoid this, at least two such radar sensors are required, but this increases manufacturing costs.

Comparatively tall motor vehicles, such as off-road vehicles or pick-ups, usually have running boards with a tread surface for easier entry, which are also known as footsteps. These are mounted below a door and extend from a lower end of the body towards the floor. This means that a person can step onto the tread surface when entering and exiting and use the running board as an intermediate step, so that they can also negotiate comparatively high differences in height.

### SUMMARY OF THE INVENTION

It is therefore an object of the invention to provide a particularly suitable running board for a motor vehicle and a particularly suitable flap system, wherein production costs are appropriately reduced, and wherein safety and/or robustness is appropriately increased, and wherein installation and/or maintenance is appropriately facilitated.

The running board is suitable, in particular provided and designed, to be attached to a motor vehicle or at least to form a component of the motor vehicle in its assembled state. The motor vehicle is suitably land-bound and preferably multi-lane. In this case, it is suitably possible to position the motor vehicle essentially freely, in particular on a roadway. For this purpose, the motor vehicle is expediently equipped with corresponding wheels. In summary, it is preferable to position the motor vehicle essentially independently of other conditions on land. In other words, the motor vehicle is appropriately not rail-bound. Preferably, the motor vehicle is a passenger car or a commercial vehicle, such as a truck or bus.

The running board has a board. The board is used for climbing on and/or supporting a person and is suitable for this purpose, in particular provided and designed. In other words, the board is a kind of step in particular, or it acts in the manner of a step. The board has a tread surface for this purpose. The tread surface, for example, is made of a comparatively non-slip material and/or is comparatively robust, so that the persons on it are supported without causing damage. It is expedient to arrange the tread surface essentially horizontally in the intended state.

For example, the board can be rigidly attached to a body of the motor vehicle when assembled. Alternatively, the board may be suitably adjustable, in particular via mechanics/kinematics of the running board. Via the mechanics/kinematics, the board is conveniently arranged on the outside of the body of the motor vehicle in the assembled state, and via the mechanics or kinematics it is possible to swivel or at least adjust the board. In particular, it is possible to adjust the distance between the board and the floor and/or at least partially set an overhang of the board over other components of the body.

The board can be associated with a flap of the motor vehicle and can be arranged in particular in the vertical direction below the flap. The flap is, for example, a door, such as a side door. For example, this can be mounted to swivel or move longitudinally on the body. Alternatively, the doors can be arranged in a rear area and designed in particular as swing doors. In this case, the board is conveniently located in a vertical direction under an opening in the body assigned to the door. For example, the motor vehicle can be designed in the manner of a train, a tram, or a bus. However, particularly preferably, the motor vehicle is a passenger car and is designed, for example, in the style of a van, off-road vehicle or pick-up. In another alternative, for example, the flap is a tailgate, and the board, in the state for which it has been designed, for example, is partially offset to the side with respect to the flap, in particular if the vehicle is designed in the style of a pick-up.

The running board includes a radar sensor. The radar sensor can have one or more radar antennas via which electromagnetic waves can be sent out and/or received. Appropriately, the radar sensor includes a transmitter and/or receiver unit, via which the radar antenna(s) is/are preferably operated. In this case, for example, the radar sensor is operated with a frequency of essentially 18 GHz, so that radar waves with a frequency of essentially 18 GHz are sent out during operation. Alternatively or in combination, frequencies between 78 GHz and 81 GHz are used. Thus, distance resolution is improved.

The radar sensor can be connected to the board and preferably attached to it. Appropriately, the board can have an edge that forms the outer border of the board. Preferably, the radar sensor is located inside the border so that it can be used to protect the radar sensor from damage. Conveniently, the edge is covered by the tread surface, and the radar sensor is conveniently located vertically below the tread surface. This means that the radar sensor is also protected from environmental influences via the tread surface.

Due to such an arrangement, the radar sensor is surrounded and thus protected, in particular via the other components of the board, which increases robustness. In addition, due to the comparatively exposed position of the board, at least in certain conditions, i.e., when the board is extended, there is a comparatively large amount of space available around it. This simplifies installation, removal, and/or maintenance. In particular, it is only necessary to remove the tread surface from the other components of the board in order to get to the radar sensor. Other components of the motor vehicle, on the other hand, such as body parts or interior trim, can be left in their respective places. In addition, due to the exposed position of the radar sensor, it is also possible to align a detection range of the radar sensor in such a way that the number of blind areas are reduced, which are formed, for example, by the body of the motor vehicle or at least caused by it. In other words, it is possible to set the detection range of the radar sensor comparatively accurately and precisely, wherein this is essentially not restricted by the other components of the motor vehicle. This makes it possible to detect the desired objects, such as obstacles, using the radar sensor, which is why safety is increased.

For example, the detection range of the radar sensor may be offset vertically below the tread surface or laterally in relation to it, at least predominantly. This makes it possible, for example, to detect an object under or next to the motor vehicle with comparative certainty. Particularly preferred, however, the detection range of the radar sensor is in a vertical direction above the tread surface. If the running board is assigned to a flap of the motor vehicle, the board is suitably located in the vertical direction below the flap so that the flap and its adjustable range are completely or at least mainly within the detection range of the radar sensor. As a result, the radar sensor makes it possible to reliably detect objects located there, so that moving the flap against them or getting them trapped can be safely avoided.

For example, the radar sensor's visual axis, around which the radar sensor's detection range is conveniently formed, and which in particular forms the symmetry axis of the detection range, can be essentially horizontally aligned or tilted to a horizontal at an angle of no more than 45°. This makes it possible to detect objects approaching the motor vehicle laterally via the radar sensor. Most preferably, however, the radar sensor's visual axis with the tread surface includes an angle between 90° and 70°. Thus, the position of the flap as well as its state and/or use can be determined comparatively precisely via the radar sensor. Consequently, depending on this, a corresponding function can be carried out in a targeted manner, for example.

Preferably, the board is driven by an electric motor drive. The electric motor drive preferably includes an electric motor. The electric motor is preferably a brushed commutator motor or, alternatively, brushless. For example, the electric motor can be a brushless direct current (BLDC) motor. The electric motor preferably has a stator as well as a rotor, which is mounted so as to rotate with respect to the stator about a rotational axis/axis of rotation, which thus corresponds to the rotational axis of the electric motor. The electric motor is designed in such a way that when a current is applied to the electric motor, a rotating magnetic field is created, due to which the rotor is set into a rotational motion with respect to the stator. Preferably, the electric motor comprises a housing via which the stator is at least partially surrounded and thus protected.

Appropriately, the electric motor drive includes a gear that is driven by the electric motor. In turn, the board is driven via the gear, preferably a kinematic/mechanical system, via which the board is connected to the body when assembled.

For example, the running board can be designed in such a way that the radar sensor is only operated when the electric motor drive is at a standstill, i.e., when the board is not moved. However, it is particularly preferred, for example, that the radar sensor be operated only, or preferably also, during an adjustment of the board. Due to the moving board, a dynamic radar measurement is carried out via the radar sensor, which increases accuracy and reliability.

For example, the board can be adjusted when the associated flap is to be opened, or especially after the flap has been closed. Alternatively, the board can also be adjusted via the electric motor drive, for example, if an object detected by the radar sensor has not been reliably detected. Due to the subsequent movement of the board and thus also of the radar sensor, improved detection is possible. In other words, the electric motor drive is thus also adjusted, at least slightly, as a function of the signals provided by the radar sensor and/or the quality of the signals provided by the radar sensor.

When assembled, the flap system can be a component of a motor vehicle, such as a passenger car. The flap system is suitable for this purpose, in particular provided and designed. The flap system has a flap. This can be designed as a tailgate, for example. Alternatively, the flap can be a door, like a side door. In the assembly state, this is mounted, for example, on a motor vehicle body in a sliding or swiveling manner. Conveniently, the flap system includes an appropriate bearing for the associated flap.

The flap system can also include a running board that is associated with the flap. In this case, for example, in its intended state, the flap is arranged in the vertical direction below the flap, in particular if the flap is designed as a door. This makes it easier for one person to enter the motor vehicle through an opening that can be closed via the associated flap. If the flap is designed as a tailgate, the motor vehicle is appropriately designed in the manner of a pick-up. The flap is preferably swiveled about a horizontal axis. In particular, in the open state of the flap, it is flush with a loading area. In this case, the running board is conveniently arranged both vertically below the flap and laterally offset from it, and in particular designed as a so-called side step. This allows for the running board to be used even when the flap is open.

The running board has a board with a tread surface. The running board also includes a radar sensor that is connected to the board. Appropriately, the flap is spaced from the radar sensor, and in particular it is possible to use the radar sensor to detect the flap and/or an adjustment range of the flaps via the radar sensor during operation. For this purpose, the radar sensor is appropriately arranged and/or the running board is designed accordingly.

Preferably, the flap system is operated in such a way that when the flap is opened, the radar sensor monitors an area in front of the flap in an opening direction for an obstacle. Via the opening movement, the flap is distanced from any openings that can be closed by the flap, so that the opening is released. The opening direction is determined in particular via the possible bearing of the flap. In summary, the radar sensor is operated expediently if any opening, which can be covered by the flap, is to be released.

In particular, the radar sensor is used, at least also, to detect the area through which the flap is subsequently passed. In particular, the detection range is at least partially directed towards the adjustment range of the flap. If an obstacle is detected there, an initial warning is issued. For example, an output device is used for this purpose, for example an acoustic or optical output device. Alternatively, for example, a corresponding signal can be sent to an on-board computer of the motor vehicle, via which the corresponding output is then triggered.

If the obstacle is there, if the flap continues to move unchanged, it is possible that the flap will be moved against the obstacle, which can lead to damage to the flap and/or damage to the obstacle. On the basis of the first warning issued, a user, an obstacle and/or a component of the motor vehicle is alerted to the fact that it is not possible to open the flap unimpeded.

For example, when the flap closes, the radar sensor is not operated, i.e., in particular if the possible opening is to be closed via the flap. However, it is particularly preferable to use the radar sensor to monitor an area in front of the flap in a closing direction for an obstacle during the closing movement of the flap. In particular, the area between the flap and the opening of the body is monitored via the radar sensor. In particular, if the obstacle is detected there, a second warning is issued. For example, the second warning can be equal to the first warning, or they may differ. For example, the flap system may include a corresponding output device for this purpose, which is particularly acoustically and/or visually designed. Alternatively, for example, a corresponding signal can be issued to an on-board computer of the motor vehicle.

If the obstacle is in this area, it is possible that it becomes trapped between the flap and the body of the motor vehicle when the flap is moved in the closing direction. Due to the second warning, the obstacle, a user, or a component of the motor vehicle is made aware that the obstacle is there so that appropriate measures can be taken.

Expediently, the flap system can be operated in accordance with a method in which the radar sensor is operated during an opening and/or closing movement of the flap and, if necessary, the first and/or second warning is issued, provided that the obstacle is detected accordingly. Appropriately, the flap system has a control unit which is provided and set up to carry out the method. The control unit includes, for example, an application-specific circuit (ASIC) or, most preferably, a computer that is suitably programmable. In particular, the control unit comprises a storage medium on which a computer program product, also known as a computer program, is stored, wherein when this computer program product, i.e., the program, is executed, the computer is triggered to execute the method.

The invention also relates to a corresponding method and such a computer program product. The computer program product includes a number of commands which, when a computer executes the program (computer program product), cause it to execute the method. The computer is conveniently a component of a control unit or electronics of the flap system and is formed, for example, via it. The computer preferably comprises a microprocessor or is formed via it. The computer program product can be a file or a disk that contains an executable program that automatically executes the method when installed on a computer.

The invention also relates to a storage medium on which the computer production is stored. Such a storage medium can be a CD-ROM, a DVD, or a Blu-Ray Disc. Alternatively, the storage medium may be a USB stick or other storage device, which may be rewritable or only writable once. Such a storage device may be a flash memory, a RAM, or a ROM.

The invention also relates to a control unit. The control unit is provided and set up to perform the method. The control unit may have an application-specific circuit (ASIC) and/or a microprocessor via which the method is at least partially carried out. In particular, the control unit comprises a computer program product which is stored in a memory and which, when the program is executed by a computer, such as the microprocessor, induces it to carry out the method. Preferably, the control unit is a component of the flap system when installed and is suitable for this purpose, in particular provided and set up.

It may only be possible to adjust the flap manually. However, the flap system is particularly preferred to include an additional electric motor via which the flap is driven. In this case, another gear is driven in particular via the additional electric motor, such as a worm gear. Via this, for example, a spindle or other component is driven, which is supported on the flap. At least when the additional electric motor is in operation, a force is exerted on the flap, and the flap system is designed accordingly. For example, when the additional electric motor is in operation, the flap is adjusted completely automatically, or a manual adjustment of a user/person is at least supported, so that the force to be applied by the user is reduced.

In particular, the flap system is designed in such a way that a request can be detected. For this purpose, the flap system may include a corresponding input device, such as a button or a handle, which can be operated by the user. Alternatively, the flap system may include an interface that can be used to detect the operation of a corresponding input device. In particular, after a corresponding request, the additional electric motor is energized so that it is moved.

For example, the operation of the additional electric motor can be independent of any first/second warning. If these are not output, it is possible to continue moving the flap unimpeded. Particularly preferably, however, the flap system is operated in such a way that the additional electric motor is stopped when the first and/or second warning is issued. In other words, for example, if the flap is moved in the closing direction via the additional electric motor, and if the obstacle is detected, the second warning is issued, and the electric motor, if any, is stopped. Alternatively or in combination with this, for example, the additional electric motor can be stopped when the radar sensor detects the obstacle, and the first warning is issued when the radar sensor is closing.

Preferably, the board is driven via the electric motor drive. If the board is to be brought into the extended state, i.e., in particular if it is to be distanced from the possible body of the motor vehicle so that it can be used by the user/person, the radar sensor is appropriately operated. Here, the radar sensor is used, for example, before and/or during the operation of the electric motor drive that the board is not moved against any obstacle, such as a curb. Therefore, damage to the running board is avoided. When the flap is opened, on the other hand, it is in particular not necessary to detect any curb via the radar sensor, since the board is located below the flap. If the board has not been moved against the curb, which in particular constitutes the obstacle, it is also not possible to move the flap against it.

For example, the radar sensor may only be used to detect a possible obstacle. Preferably, however, an icing condition is determined, at least implicitly. In particular, it is determined whether the device is iced over, or at least whether there is a condition of possible icing, i.e., in particular whether the probability of icing is increased and/or above a limit value. In particular, corresponding measured values are recorded for this purpose, or these are provided by an on-board computer of the motor vehicle and read out via the flap system. For example, the board is assumed to be icy if the ambient temperature of the motor vehicle or the temperature of the flap system is less than a limit value that is particularly 0° C. In a further development, for example, it is also necessary that a certain humidity prevails.

Depending on the determined icing condition, the radar sensor is operated to defrost the tread surface. Thus, if it has been determined that the board/the flap system/the tread surface is icy, or at least there is a probability of this, the radar sensor is operated. For this purpose, the radar sensor in particular is operated with a corresponding power and/or frequency, so that a comparatively large amount of thermal radiation is emitted. In particular, radar waves are operated with comparatively large electrical power and/or at least losses. Alternatively or in combination with this, the radar sensor is operated with a comparatively high power and/or frequency, so that a comparatively high-power output occurs within a short distance to the radar sensor construction. Due to the heat provided in this way, the radar sensor and therefore also the tread surface are heated and thus defrosted. This ensures that a person/user does not slip on the tread surface if they want to use it, which increases safety. No additional component is required, which is why production costs are reduced.

The icing condition can be determined essentially continuously, and when it has been determined that icing is present, the radar sensor in particular is immediately operated accordingly. This avoids, for example, the formation of a comparatively thick layer of ice, and the running board can essentially be used immediately. Alternatively, defrosting may be carried out only if the use of the running board is imminent or at least the probability of this is high. For example, the speed of the motor vehicle may be monitored, and if it falls below a limit speed, the radar sensor is operated accordingly. In an alternative, defrosting only takes place when the motor vehicle is stationary or when the motor vehicle has sufficiently approached a desired destination. For example, data from a navigation system may be retrieved for this purpose. Alternatively or in combination with this, defrosting may be started, for example, when the user approaches the parked motor vehicle and/or the latter is unlocked. In another alternative, for example, the radar sensor may only be operated for defrosting when a request to adjust the flap or at least the board has been detected. In particular, the radar sensor is then operated for defrosting while the board is being adjusted.

In particular, the flap system can be operated in accordance with the method in which the radar sensor is operated to defrost the tread surface depending on the icing condition. Expediently, the possible control unit is designed accordingly for this purpose.

The invention also relates to a motor vehicle with a corresponding flap system. The motor vehicle is suitably land-bound and, for example, a passenger car. Alternatively, the motor vehicle is a commercial vehicle, for example a truck or a bus. The motor vehicle includes in particular a body with an opening. In this case, the opening can be covered via the flap, which is conveniently mounted on the body in an adjustable manner, for example via a hinge and/or a rail.

The advantages and further developments mentioned in connection with the running board are also to be transferred mutatis mutandis to the flap system/the method/the computer program product/the storage medium/the control unit/the motor vehicle and to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description hereinbelow and the accompanying drawings which are given by way of illustration only, and thus, are not limited of the present invention and wherein:

FIG. 1 shows schematically, a motor vehicle comprising a flap system with a flap designed as a door and a running board,

FIG. 2 shows schematically, in a cross-sectional view, perpendicular to the longitudinal axis of the motor vehicle, the flap system, and

FIG. 3 is a method for operating the flap system.

### DETAILED DESCRIPTION

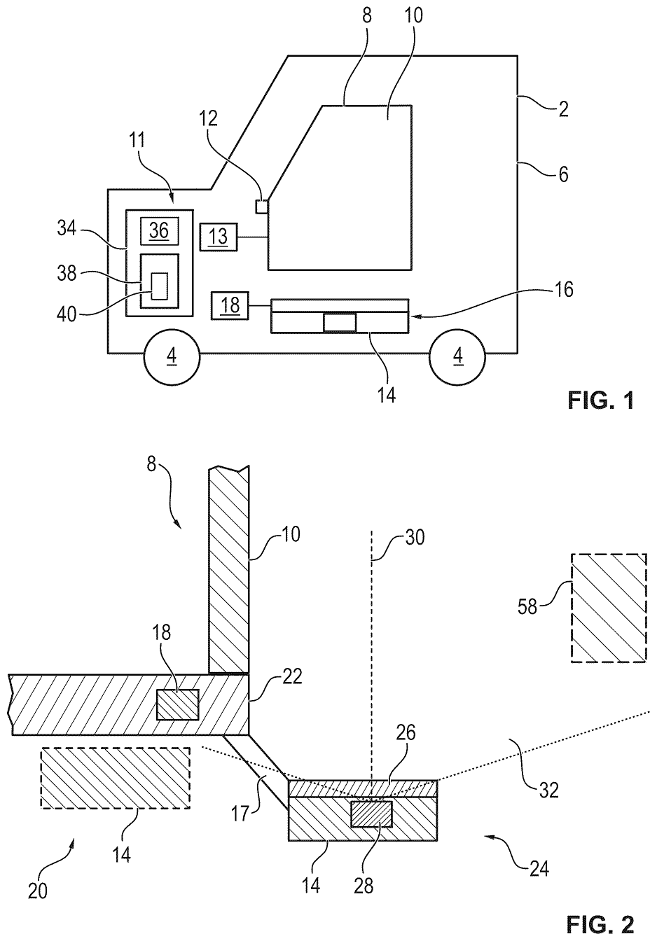

FIG. 1 shows a motor vehicle 2 in the form of a passenger car in a schematically simplified manner. The motor vehicle 2 has several wheels 4 that stand on the ground and are connected to a body 6 via an unspecified chassis. The motor vehicle 2 may be designed as a pick-up and has comparatively large wheels 4 and a corresponding chassis. As a result, a lower edge of the body 6 is comparatively far from the ground.

The body 6 has an opening 8, which can be covered via a flap 10 of a flap system 11. For this purpose, the flap 10, which is designed as a side door, is movably attached to the body 6 via a hinge 12. The flap 10 is driven via an additional electric motor 13 of the flap system 11, which is fixed to the body 6, so that the flap 10 can be swiveled by operating the additional electric motor 13. It is possible to perform an opening movement so that the flap 10 is moved in an opening direction, which is predetermined by the hinge 12. When the flap 10 is moved along the opening movement, the opening 8 is released. By energizing the additional electric motor 13 in the opposite direction, however, a closing movement is performed and the flap 10 is moved in a closing direction that is opposite to the opening direction and is also predetermined by the hinge 12. When the closing movement is complete, the opening 8 is covered by the flap 10 and thus closed.

In the vertical direction below the door, a board 14 of a running board 16 is adjustably mounted on the body 6 via a mechanism 17, as shown schematically in FIG. 2 in a cross-sectional representation perpendicular to the longitudinal axis of the motor vehicle 2. The running board 16 also forms part of the flap system 11, and the board 14 is essentially arranged horizontally and driven by the mechanism 17 via an electric motor drive 18 of the running board 16. The electric motor drive 18 has an electric motor that is not shown in detail, via which a gear is driven, which in turn is in active connection with the mechanism 17. It is possible to use the electric motor drive 18 to move the board 14 with respect to the body 6, i.e., to retract and extend it. In a retracted state 20, the board 14 is offset inwards with respect to a lateral outer edge 22 of the body 6.

In an extended state 24, the board 14 protrudes beyond the body 6 below the opening 8. Thus, a person can use the board 14 as a step to enter or exit through the opening 8. For this purpose, the board 14 has a tread surface 26, which serves as a step for the person and is correspondingly stable. Also, the tread surface 26 forms the upper boundary of the board 14 in the vertical direction. In summary, the running board 16 is associated with the flap 10.

The running board 16 also includes a radar sensor 28, which is connected to the board 14 and attached there. Here, the radar sensor 28 is disposed in a receptacle of the board 14, which is located below the tread surface 26 and is not shown in detail. The visual axis 30 of the radar sensor 28 includes an angle of 90° with the tread surface 26 and is therefore perpendicular to the tread surface 26. Around the visual axis 30 of the radar sensor 28, a detection range 32 is formed. The visual axis 30 represents a symmetry axis of the detection range 32, at least if there are no disturbing elements within the detection range 32. The detection range 32 of the radar sensor 28 is located in a vertical direction above the tread surface 26, so that the flap 10 and the opening 8 are located in the detection range 32, at least if the board 14 is in the extended state 24.

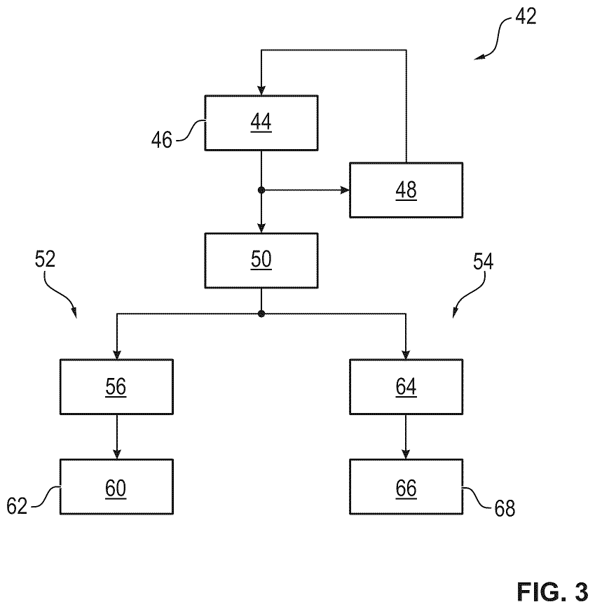

The flap system 11 also has a control unit 34 with a computer 36 in the form of a microprocessor. The control unit 34 also comprises a memory 38 in which a computer program product 40 is stored. The computer program product 40 comprises a number of commands which, when executed by the computer 36, cause it to perform a method 42 for the operation of the flap system 11 shown in FIG. 3. In other words, the flap system 11 is operated in accordance with the method 42.

In the method 42, an icing condition 46 is determined in a first step 44. This checks whether icing of the running board 16, namely the tread surface 26, is possible. This is the case when the outdoor temperature is below 0° C., which is queried via an unspecified interface of an on-board computer of the motor vehicle 2. Subsequently, the radar sensor 28 is operated and the measurement data determined with it is analyzed. If this shows that precipitation has formed on the tread surface 26, which corresponds, for example, to an ice crust, the icing condition 46 is determined to be that the tread surface 26 has iced over. In this case, a second step 48 is carried out. In this, the radar sensor 28 is operated with a comparatively high power, wherein the frequency of the radar waves is chosen in such a way that they have a comparatively short range. This means that a comparatively large amount of energy is introduced into the tread surface 26 and to any precipitation that may have formed on the latter. Also, due to the heat loss generated when the radar sensor 28 is in operation, the tread surface 26 connected to it is heated. In summary, the radar sensor 28 is operated to defrost the tread surface 26. In this case, the second step 48 is only carried out if it has been determined that the tread surface 26 is iced over. Consequently, such operation takes place depending on the icing condition 46. After the second step 48 has been carried out for a certain period of time, the first step 44 is carried out again and thus it is determined again whether the tread surface 26 is iced over.

If a request to adjust the flap 10 is detected, a third step 50 is performed.

The request is created via an input device that is not shown in detail, such as a door handle. In this case, either it is either stored in the request or it can be determined on the basis of the current position of the flap 10 as to whether an opening movement 52 or a closing movement 54 of the flap 10 is to be performed. At least, it is determined in the third step 50 as to whether the opening movement 52 or the closing movement 54 should take place.

If the opening movement 52 is to be performed, a fourth step 56 is performed. In this, the electric motor drive 18 is operated, so that the board 14 is moved from the retracted state 20 to the extended state 24. Meanwhile, the radar sensor 28 is operated to detect an obstacle 58 in the detection range 32. Due to the movement of the board 14, the radar sensor 28 and thus also the detection range 32 moves, so that a dynamic radar measurement is carried out via the radar sensor 28, which is why the accuracy of detecting the obstacle 58 is improved if it is present.

If the obstacle 58 is not present, the additional electric motor 13 is operated so that flap 10 is adjusted in an opening direction. In the meantime, the radar sensor 28 continues to be operated, wherein the radar sensor 28 is used to monitor the area in front of the flap 10 in the opening direction for the obstacle 58. If no obstacle 58 is detected in this area, i.e., in the area in which the flap 10 will be located if the additional electric motor 13 continues to operate unimpeded, and which corresponds to the adjustment range of the flap 10, the flap 10 is adjusted along the complete adjustment range and the opening 8 is released to the maximum.

However, if the obstacle 58 is detected, a fifth step 60 is performed. In this, a first warning 62 is issued, which is provided to the on-board computer of the motor vehicle, via which the first warning 62 is output acoustically. The additional electric motor 13 is also stopped, so that the adjustment of the flap 10 is terminated. As a result, the flap 10 is prevented from moving towards the obstacle 58, wherein, for example, the opening 8 is still partially uncovered, so that a person can enter or exit.

If the closing movement 54 is to be performed, the flap 10 is open, and the board 14 is in the extended state 24. In a sixth step 64, the radar sensor 28 is operated, with the opening 8 as well as the flap 10 abutting in the detection range 32. Here, too, the radar sensor 28 is used to check whether the obstacle 58 is present in the direction of movement of the flap 10. In this case, however, the direction of movement is oriented in the direction of opening 8. Consequently, during the closing movement 54 of the flap 10, the area located in the closing direction in front of the flap 10 is monitored for the obstacle 58 by the radar sensor 28. This area is located between the flap 10 and the opening 8. If no obstacle 58 is detected, the flap 10 is moved to the closed state so that opening 8 is covered.

If the obstacle 58 is detected, a seventh step 66 is carried out and a second warning 68 is issued. This is sent to the on-board computer, which is not shown in detail, so that an acoustic warning can be issued via it. The additional electric motor 13 is also stopped so that the obstacle 58 does not get jammed between the flap 10 and the body 6.

The invention is not limited to the examples described above. On the contrary, other variants of the invention can also be derived by the skilled person from this without departing from the subject-matter of the invention. In particular, all the individual features described in connection with the individual examples/embodiments can also be combined in other ways without departing from the subject-matter of the invention.

What is claimed is:

1. A running board for a motor vehicle, the running board comprising:
a board;
a tread surface arranged on the board; and
a radar sensor arranged on the board.

2. The running board according to claim 1, wherein a detection range of the radar sensor is located in a vertical direction above the tread surface.

3. The running board according to claim 2, wherein a visual axis of the radar sensor encloses an angle between 90° and 70° with the tread surface.

4. The running board according to claim 1, wherein the board is driven via an electric motor drive.

5. A flap system for a motor vehicle, the flap system comprising a flap with which the running board according to claim 1 is associated.

6. The flap system according to claim 5, wherein the flap system is operated in such a way that when the flap is opened, an area located in an opening direction in front of the flap is monitored for an obstacle via the radar sensor, and wherein a first warning is issued when the obstacle is detected.

7. The flap system according to claim 5, wherein the flap system is operated in such a way that in the event of a closing movement of the flap, an area in a closing direction in front of the flap is monitored for an obstacle via the radar sensor, and wherein a second warning is issued when the obstacle is detected.

8. The flap system according to claim 5, wherein the flap is driven via an additional electric motor, and wherein the flap system is operated in such a way that the additional electric motor is stopped when one of the warnings is issued.

9. The flap system according to claim 5, wherein the flap system is operated in such a way that an icing condition is determined, and wherein, depending on the icing condition, the radar sensor is operated for defrosting the tread surface.
